(19) United States
(12) Patent Application Publication
(10) Pub. No.: US 2022/0334411 A1
(43) Pub. Date: Oct. 20, 2022

(54) Automatic Illuminating Glasses Apparatus

(71) Applicant: James Pastore, JR., East Rockaway, NY (US)

(72) Inventor: James Pastore, JR., East Rockaway, NY (US)

(21) Appl. No.: 17/235,496

(22) Filed: Apr. 20, 2021

(51) Int. Cl. G02C 11/04; G02C 11/00

(52) U.S. Cl. CPC G02C 11/04; G02C 11/10

(57) ABSTRACT

An automatic illuminating glasses apparatus for automatically illuminating dimly lit environments includes a frame having a bridge and a pair of temples. A pair of lenses is coupled to the frame. A pair of arms is coupled to the frame and is pivotably coupled to the pair of temples. At least one light is coupled to the frame. A sensor is coupled to the frame and is in operational communication with the light. A battery is coupled within one of the arms and is in operational communication with the lights. A microprocessor is coupled within one of the arms and is in operational communication with the sensor and the lights. A power button is coupled to the pair of arms and is in operational communication with the microprocessor to selectively turn the lights on, off, or to automatically illuminate when the sensor detects low light environments.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to glasses devices and more particularly pertains to a new glasses device for automatically illuminating dimly lit environments. The present device includes a pair of lights integrated into the glasses frame. There is a light sensor in operational communication with the pair of lights to illuminate automatically if desired. There may also be an induction coil integrated into one of the arms for wireless charging.

### (2) Description of Related Art Including Information Disclosed Under 37 CFR 1.97 and 1.98

The prior art relates to glasses devices. Known device have attached lights but typically do not have lights integrated and flush mounted with the frame. These devices also do not automatically illuminate in low light environments.

### BRIEF SUMMARY OF THE INVENTION

An embodiment of the disclosure meets the needs presented above by generally comprising a frame having a bridge and a pair of temples. A pair of lenses is coupled to the frame. A pair of arms is coupled to the frame and is pivotably coupled to the pair of temples. At least one light is coupled to the frame. A sensor is coupled to the frame and is in operational communication with the light. A battery is coupled to the pair of arms. The battery is coupled within one of the arms and is in operational communication with the lights. A microprocessor is coupled to the pair of arms. The microprocessor is coupled within one of the arms and is in operational communication with the sensor and the lights. A power button is coupled to the pair of arms. The power button is in operational communication with the microprocessor to selectively turn the lights on, off, or to automatically illuminate when the sensor detects low light environments.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an automatic illuminating glasses apparatus according to an embodiment of the disclosure.

FIG. 2 is a side elevation view of an embodiment of the disclosure.

FIG. 3 is a side elevation view of an embodiment of the disclosure.

FIG. 4 is a front elevation view of an embodiment of the disclosure.

FIG. 5 is a front elevation view of an embodiment of the disclosure.

FIG. 6 is a side elevation view of an embodiment of the disclosure.

FIG. 7 is a side elevation view of an embodiment of the disclosure.

FIG. 8 is an isometric view of an embodiment of the disclosure

### DETAILED DESCRIPTION OF THE INVENTION

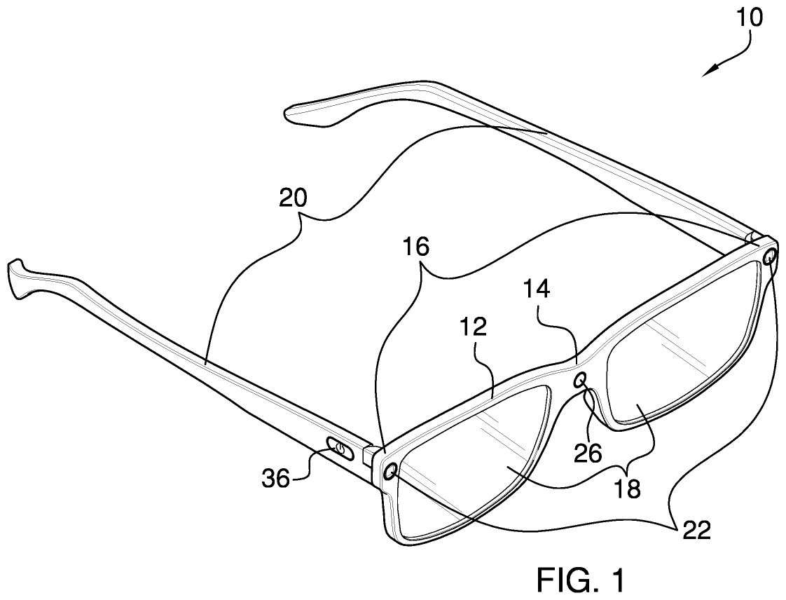

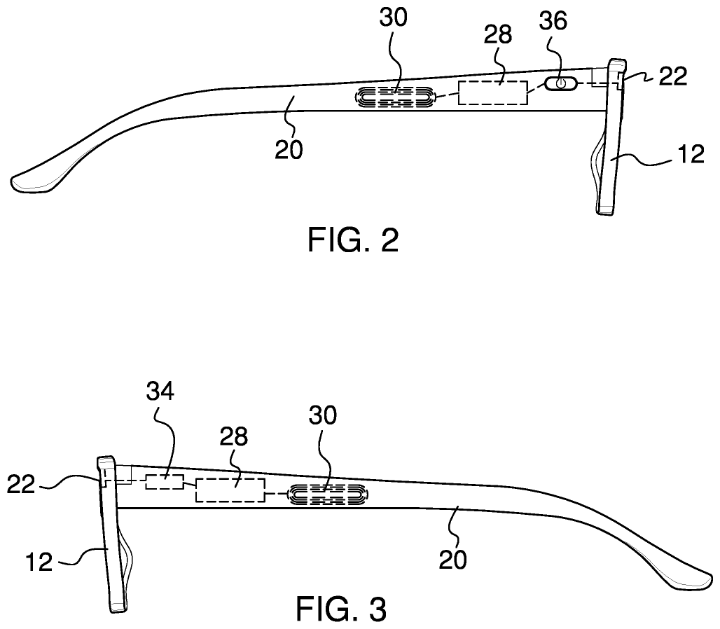

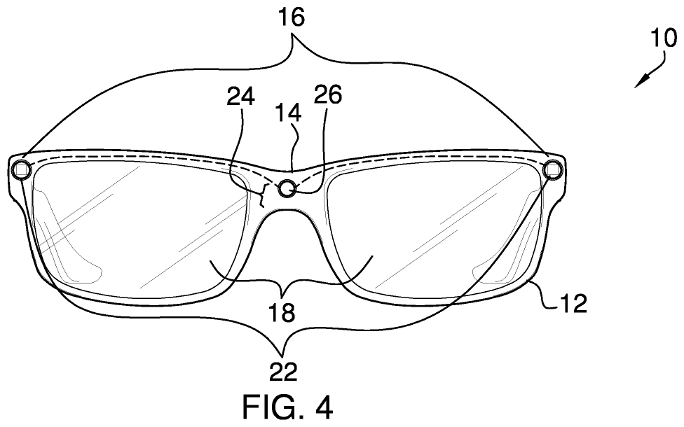

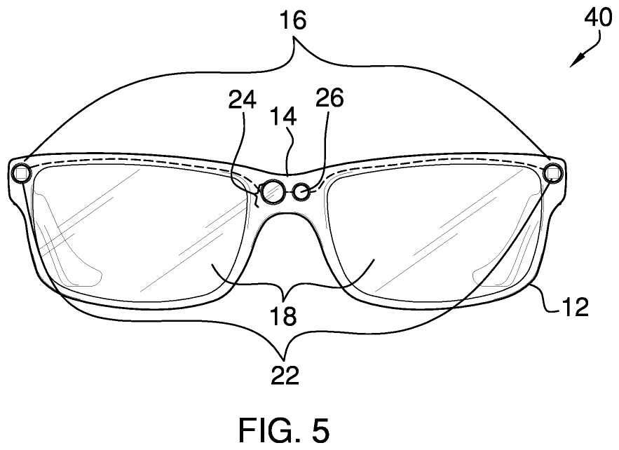

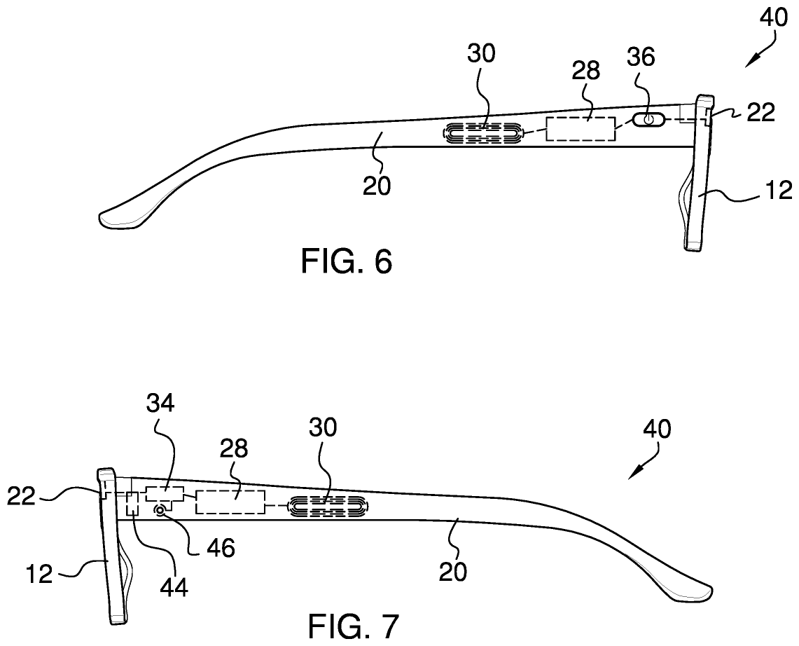

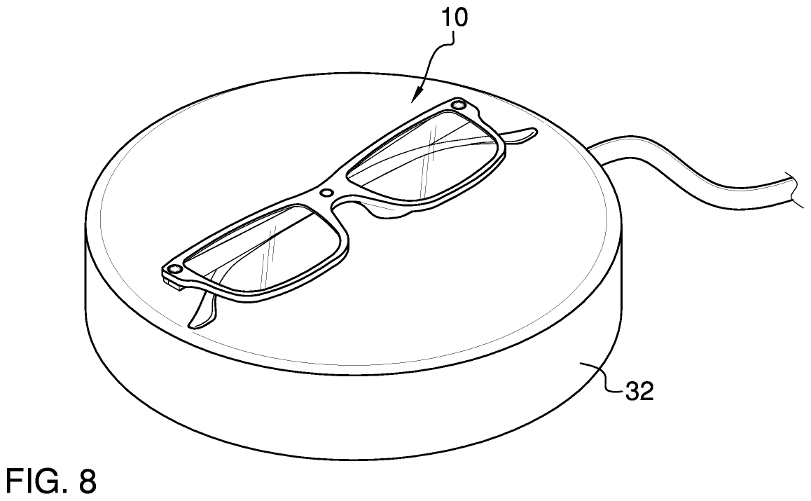

With reference now to the drawings, and in particular to FIGS. 1 through 8 thereof, a new glasses device embodying the principles and concepts of an embodiment of the disclosure and generally designated by the reference numeral 10 will be described.

As best illustrated in FIGS. 1 through 8, the automatic illuminating glasses apparatus 10 generally comprises a frame 12 having a bridge 14 and a pair of temples 16. A pair of lenses 18 is coupled to the frame 12. A pair of arms 20 is coupled to the frame 12. The pair of arms 20 may be pivotably coupled to the pair of temples 16.

At least one light 22 is coupled to the frame 12. The lights 22 may be a pair of lights 22 coupled to the pair of temples 16 of the frame. The pair of lights 22 may be flush mounted to a frame front side 24 of the frame and may be light emitting diodes (LEDs). A sensor 26 is coupled to the frame 12. The sensor 26 is in operational communication with the lights 22. The sensor 26 may be coupled to the bridge 14 of the frame. The sensor 26 may be flush mounted to the frame front side 24 of the frame.

A battery 28 is coupled to the pair of arms 20. The battery 28 is coupled within one of the arms 20 and is in operational communication with the lights 22. The battery 28 may be a pair of batteries 28 coupled within the pair of arms 20. Each battery 28 of the pair of batteries may include an induction coil 30 configured to be in operational communication with a wireless charging pad 32.

A microprocessor 34 is coupled to the pair of arms 20. The microprocessor 34 is coupled within one of the arms 20 and is in operational communication with the sensor 26 and the lights 22. A power button 36 is coupled to the pair of arms 20. The power button 26 is in operational communication with the microprocessor 34 to selectively turn the lights 22 on, off, or to automatically illuminate when the sensor 26 detects low light environments.

In an alternative embodiment of the invention 40, a camera 42 is coupled to the frame 12. The camera 42 may be coupled to the bridge 14 adjacent the sensor 26. The camera 42 may be flush mounted to the frame front side 24. A wireless transmitter 44 is coupled to the pair of arms 20. The wireless transmitter 44 is in operational communication with the camera 42 and the microprocessor 34. A microphone 46 may be coupled to the pair of arms 20. The microphone 46 is in operational communication with the microprocessor 34 and the wireless transmitter 44.

In use, the apparatus 10 is worn like a traditional pair of glasses. The power button 26 is used to control the lights 22. The alternative embodiment 40 is placed in wireless communication with a personal electronic device 48 using the wireless transmitter 44 to send video and audio signal from the camera 42 and the microphone 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automatic illuminating glasses apparatus comprising:
a frame, the frame having a bridge and a pair of temples;
a pair of lenses coupled to the frame;
a pair of arms coupled to the frame, the pair of arms being pivotably coupled to the pair of temples;
at least one light coupled to the frame;
a sensor coupled to the frame, the sensor being in operational communication with the light;
a battery coupled to the pair of arms, the battery being coupled within one of the arms and being in operational communication with the lights;
a microprocessor coupled to the pair of arms, the microprocessor being coupled within one of the arms and being in operational communication with the sensor and the lights; and
a power button coupled to the pair of arms, the power button being in operational communication with the microprocessor to selectively turn the lights on, off, or to automatically illuminate when the sensor detects low light environments.

2. The automatic illuminating glasses apparatus of claim 1 further comprising the lights being a pair of lights coupled to the pair of temples of the frame.

3. The automatic illuminating glasses apparatus of claim 2 further comprising the pair of lights being flush mounted to a frame front side of the frame.

4. The automatic illuminating glasses apparatus of claim 1 further comprising the battery being a pair of batteries coupled within the pair of arms.

5. The automatic illuminating glasses apparatus of claim 5 further comprising each battery of the pair of batteries including an induction coil configured to be in operational communication with a wireless charging pad.

6. The automatic illuminating glasses apparatus of claim 1 further comprising the sensor being coupled to the bridge of the frame.

7. The automatic illuminating glasses apparatus of claim 6 further comprising the sensor being flush mounted to a frame front side of the frame.

8. An automatic illuminating glasses apparatus comprising:
a frame, the frame having a bridge and a pair of temples;
a pair of lenses coupled to the frame;
a pair of arms coupled to the frame, the pair of arms being pivotably coupled to the pair of temples;
at least one light coupled to the frame, the lights being a pair of lights coupled to the pair of temples of the frame, the pair of lights being flush mounted to a frame front side of the frame;
a sensor coupled to the frame, the sensor being in operational communication with the light, the sensor being coupled to the bridge of the frame, the sensor being flush mounted to the frame front side of the frame;
a battery coupled to the pair of arms, the battery being coupled within one of the arms and being in operational communication with the lights, the battery being a pair of batteries coupled within the pair of arms, each battery of the pair of batteries including an induction coil configured to be in operational communication with a wireless charging pad;
a microprocessor coupled to the pair of arms, the microprocessor being coupled within one of the arms and being in operational communication with the sensor and the lights; and
a power button coupled to the pair of arms, the power button being in operational communication with the microprocessor to selectively turn the lights on, off, or to automatically illuminate when the sensor detects low light environments.

9. The automatic illuminating glasses apparatus of claim 8 further comprising a camera coupled to the frame; a wireless transmitter coupled to the pair of arms, the wireless transmitter being in operational communication with the camera and the microprocessor.

10. The automatic illuminating glasses apparatus of claim 9 further comprising the camera being coupled to the bridge of the frame, the camera being flush mounted to the frame front side.

11. The automatic illuminating glasses apparatus of claim 9 further comprising a microphone coupled to the pair of arms, the microphone being in operational communication with the microprocessor and the wireless transmitter.
